(19) United States
(12) Patent Application Publication
(10) Pub. No.: US 2003/0040327 A1
(43) Pub. Date: Feb. 27, 2003

(54) Apparatus and method for designating a recipient for transmission of a message in a mobile terminal

(75) Inventor: Yong-Kook Park, Songnam-shi (KR)

Correspondence Address: Paul J. Farrell, DILWORTH & BARRESE, LLP, 333 Earle Ovington Blvd., Uniondale, NY, 11553, US

(73) Assignee: SAMSUNG ELECTRONICS CO., LTD., KYUNGKI-DO (KR)

(21) Appl. No.: 10/227,685

(22) Filed: Aug. 26, 2002

(30) Foreign Application Priority Data
Aug. 25, 2001 (KR) 2001-51546

(51) Int. Cl. H04Q 7/20

(52) U.S. Cl. 455/466; 455/550

(57) ABSTRACT

An apparatus and method for facilitating designation of an SMS or E-mail recipient in a mobile terminal. In the SMS/E-mail recipient designation method, upon sensing a completed text entrance, a recipient designation display is displayed. If a user inputs a recipient's phone number/E-mail directly or a long key corresponding to the recipient's phone number/E-mail, the recipient's phone number/E-mail is displayed. Finally, if the user confirms, a message notifying transmission in progress is displayed and an SMS message/E-mail is transmitted contemporaneously.

### PRIORITY

This application claims priority to an application entitled “Apparatus and Method for Designating Recipient For Transmission of SMS Message or E-Mail in Mobile Terminal” filed in the Korean Industrial Property Office on Aug. 25, 2001 and assigned Serial No. 2001-51546, the contents of which are hereby incorporated by reference.

### BACKGROUND OF THE INVENTION

1. Field of the Invention

The present invention relates generally to an apparatus and method for transmitting a message in a mobile terminal, and in particular, to an apparatus and method for facilitating designation of an SMS or E-mail recipient.

2. Description of the Related Art

In order to transmit a message in a mobile terminal, the recipient of the message should be designated by, for example, entering the phone number of the recipient. That is, when transmitting an SMS (Short Message Service) message, the phone number of its recipient is entered. To enter the phone number of the recipient, keys are usually used, or a phone book is searched. The same thing occurs for E-mail transmission.

FIG. 1 illustrates a keypad in a mobile terminal for use in transmitting an SMS message or E-mail and FIG. 2 illustrates successive displays involved with a conventional SMS message transmission procedure in the mobile terminal. Referring to FIGS. 1 and 2, if a user selects a menu item “letter write” from an outgoing message menu 201, a letter write menu 202 is displayed. Upon selection of a menu item “new text write”, a window 203 to write a new text on is invoked. After the user writes a new sentence, for example “Hello” and confirms it, a display 204 prompting the user to enter the phone number of a recipient is provided. The user enters the recipient's phone number (e.g., 011300300) by hand, or he gets the phone number from a phone book by entering the name of the recipient, or he searches recipients by group, selects the recipient among the searched names, and then gets the number. Then, a window 205 to write the phone number of the user on is invoked. After the user enters his phone number (e.g., 0119769410) and confirms it, the phone number is displayed and then a message “being transmitted” is displayed (206).

The above-described recipient designation method for transmission of an SMS message is rather time-consuming and inconvenient because the phone number of the recipient must be input by hand. Moreover, it takes a long time to designate a recipient when transmitting an E-mail due to input of a relatively long character stream, when compared to transmitting an SMS message. Users of SMS are mostly young and SMS messages are usually exchanged between friends. This means that SMS recipients can be found within a particular range. It often occurs that a user sends a large number of SMS messages to a single recipient. In this case, it is very annoying to input the entire phone number of the recipient at each transmission. In addition, the problem of wrong delivery of an SMS message may arise from an error that is likely to be generated from misdialing.

Recently, rapid growth of the wireless Internet market has brought with it an increasing demand for E-mail transmission via mobile terminals. Nonetheless, recipient designation for E-mail is still even more inconvenient as compared with SMS.

### SUMMARY OF THE INVENTION

It is, therefore, an object of the present invention to provide an apparatus and method for facilitating rapid designation of a recipient when transmitting an SMS message or E-mail in a mobile terminal.

The above and other objects are achieved by providing an apparatus and method for facilitating designation of an SMS or E-mail recipient in a mobile terminal. In the SMS/E-mail recipient designation apparatus, a memory stores a phone book in which hot keys are assigned to SMS/E-mail recipients for short dialing, and a searcher searches for a phone number/E-mail address corresponding to a hot key upon input of the hot key from a user.

In the SMS/E-mail recipient designation method, upon sensing a completed text entrance, a recipient designation display is displayed. If a user inputs a recipient's phone number/E-mail address directly or a long key corresponding to the recipient's phone number/E-mail address, the recipient's phone number/E-mail address is displayed. Then, a user's phone number/E-mail address writing display is provided. Upon receipt of a user's phone number/E-mail address, the user's phone number/E-mail address is displayed. If the user confirms the user's phone number/E-mail address, a message notifying transmission in progress is displayed and an SMS message/E-mail is transmitted contemporaneously.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates a keypad in a mobile terminal for transmitting an SMS message or E-mail;

FIG. 2 illustrates an example of displays involved with transmitting an SMS message in a conventional mobile terminal;

FIG. 3 is a block diagram of an apparatus for transmitting an SMS message or E-mail in a mobile terminal according to an embodiment of the present invention;

FIG. 4 illustrates an example of displays involved with transmitting an SMS message in the mobile terminal according to the embodiment of the present invention;

FIG. 5 illustrates another example of displays involved with transmitting an SMS message in the mobile terminal according to the embodiment of the present invention;

FIG. 6 illustrates an example of displays involved with transmitting an E-mail in the mobile terminal according to the embodiment of the present invention; and

FIGS. 7A and 7B are flowcharts illustrating an SMS message transmitting method in the mobile terminal according to the embodiment of the present invention.

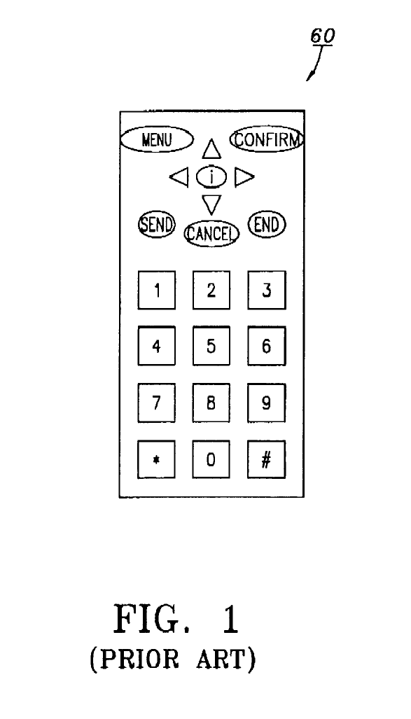

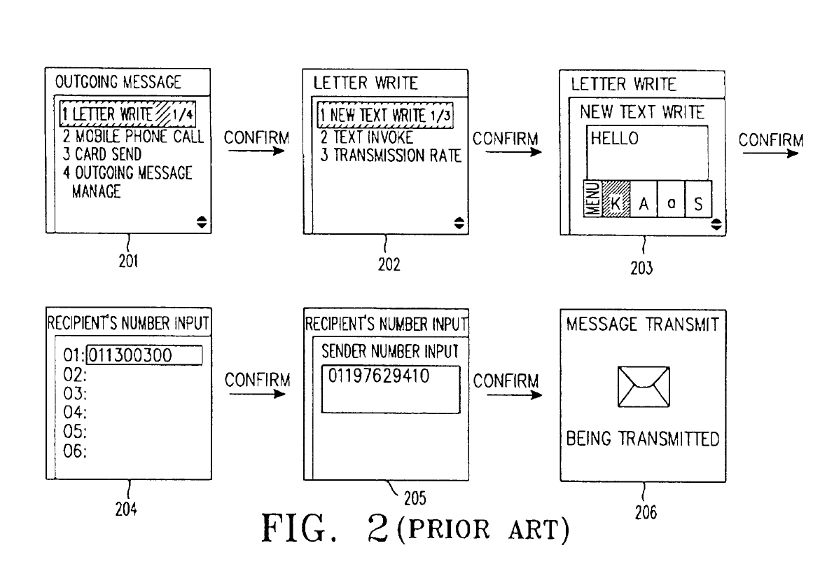

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail.

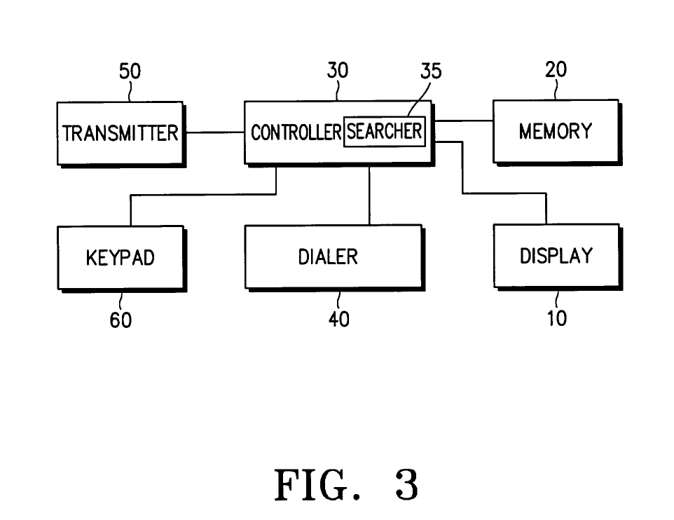

FIG. 3 is a block diagram of an apparatus for transmitting an SMS message or E-mail in a mobile terminal according to an embodiment of the present invention. Referring to FIG. 3, a display 10 displays an input mode selection window so that a user can select between a digit input mode and a hot key input mode. A memory 20 stores a phone book in which first-type long keys or hot keys are assigned to recipients of SMS messages, multimedia SMS messages, and notes, or an address book in which first-type long keys or hot keys are assigned to E-mail recipients. The first-type long keys are set in the memory. The message recipients are set in the phone book of the memory. The first-type long keys are one-digit numbers mapped to recipients on a one-to-one basis. When a specific one-digit number is pressed and held down for a predetermined period of time, a searcher searches for a corresponding recipient in the memory. A hot key refers to storing a phone number or E-mail address under a shorter number (e.g., 001).

A controller 30 provides overall control to the mobile terminal. A searcher 35 searches for a corresponding phone number when the user presses a long key or a hot key in an input mode after editing an SMS message or E-mail. A dialer 40 automatically dials the searched phone number. A transmitter 50 wirelessly transmits the SMS message or E-mail when a connection line is established by the dialing. A keypad 60 has digit keys for inputting a long key, a hot key, or a phone number, and function keys. One of the function keys can be used to confirm menu selection and input of a long key, a hot key, or a phone number.

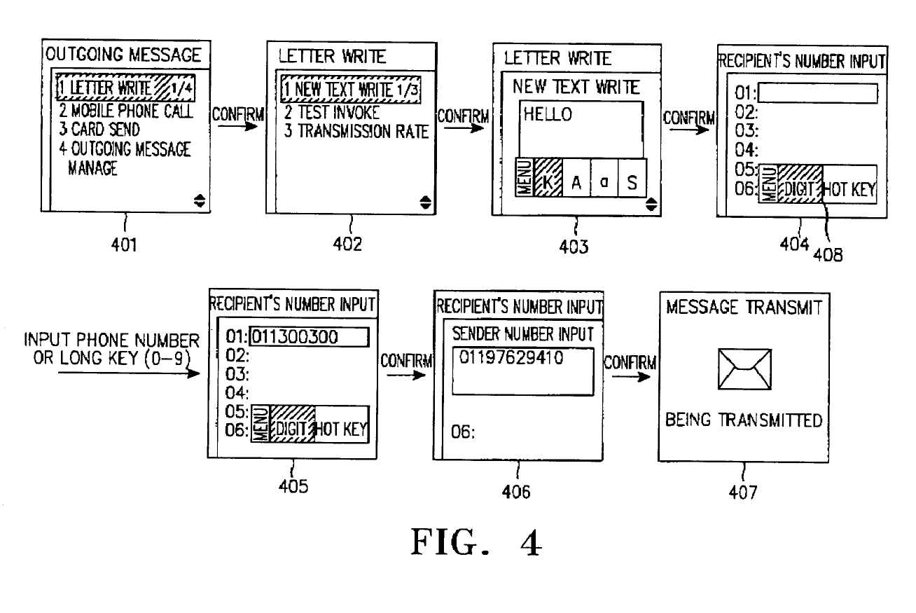

FIG. 4 illustrates an example of displays involved with transmitting an SMS message in the mobile terminal according to the embodiment of the present invention. Referring to FIG. 4, if the user selects a menu item “letter write” from an outgoing message menu 401 and presses a key Confirm, a letter write menu 402 is displayed. Upon selection of a menu item “new text write” and pressing of the key Confirm, a window 403 to write a new text on is invoked. After the user writes a new sentence, for example “Hello” and confirms it, a display 404 prompting the user to enter the phone number of a recipient is provided. When the user enters the recipient's number (e.g., 011300300) by hand, or presses a first-type long key corresponding to the recipient's phone number, a window 405 displaying a user's phone number is invoked. After the user enters his phone number (e.g., 0119769410) and confirms it, or the sender's phone number is automatically displayed (406), a message “being transmitted” is displayed (407).

A selection window 408 is provided in the lower part of the recipient's number input display 404 to allow the user to set an intended input mode. In the case of an SMS message, he can select “digit input” or “hot key input”. In the case of an E-mail, he can select “E-mail recipient input” or “hot key input” (not shown). The selection window 408 includes “menu”, “digit” and “hot key”. Input mode transition occurs by pressing a Menu key. That is, each time the Menu key is pressed, “number” and “hot key” are alternately selected, thereby toggling the digit input mode and the hot key input mode. If the digit input mode is set, the recipient's phone number is input manually or with a first-type long key, and if the hot key input mode is set, a short phone number (e.g., 001, 1, 20), or a first-type long key is input.

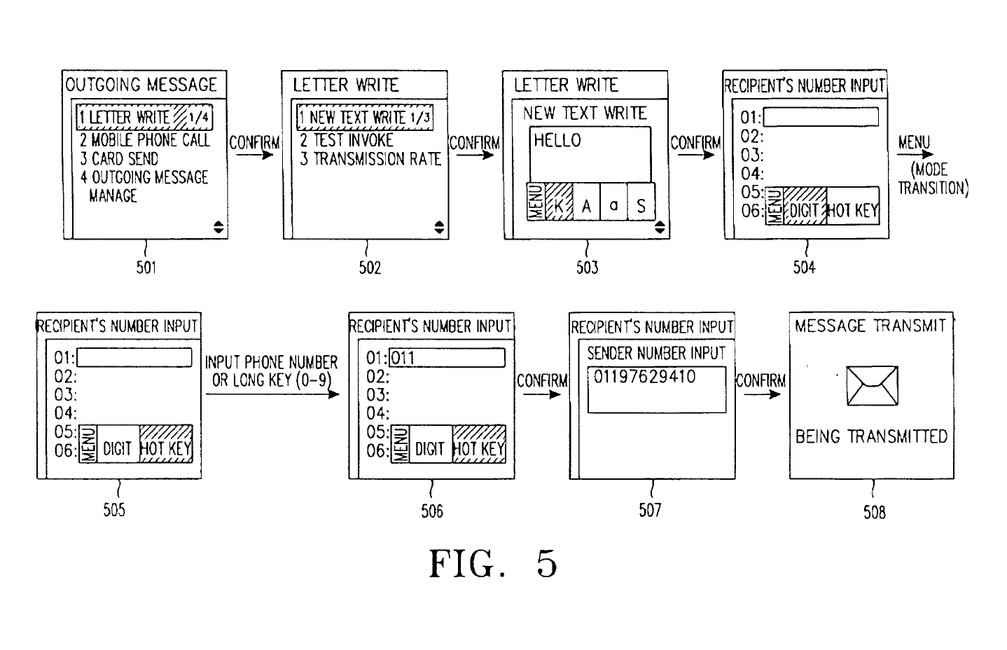

FIG. 5 illustrates another example of displays involved with transmitting an SMS message in the mobile terminal according to the embodiment of the present invention. Referring to FIG. 5, if the user selects a menu item “letter write” from an outgoing message menu 501 and presses the key Confirm, a letter write menu 502 is displayed. Upon selection of a menu item “new text write” and pressing of the key Confirm, a window 503 to write a new text on is invoked. After the user writes a new sentence, for example “Hello” and confirms it, a display 504 prompting the user to enter the phone number of a recipient is provided. When the user inputs a hot key (e.g., 001) or a first-type long key corresponding to the recipient's number, the recipient's number is displayed and a window to write a user's phone number on is invoked. After the user enters his phone number (e.g., 0119769410) or a registered number is automatically displayed, and confirms it, a message “being transmitted” is displayed.

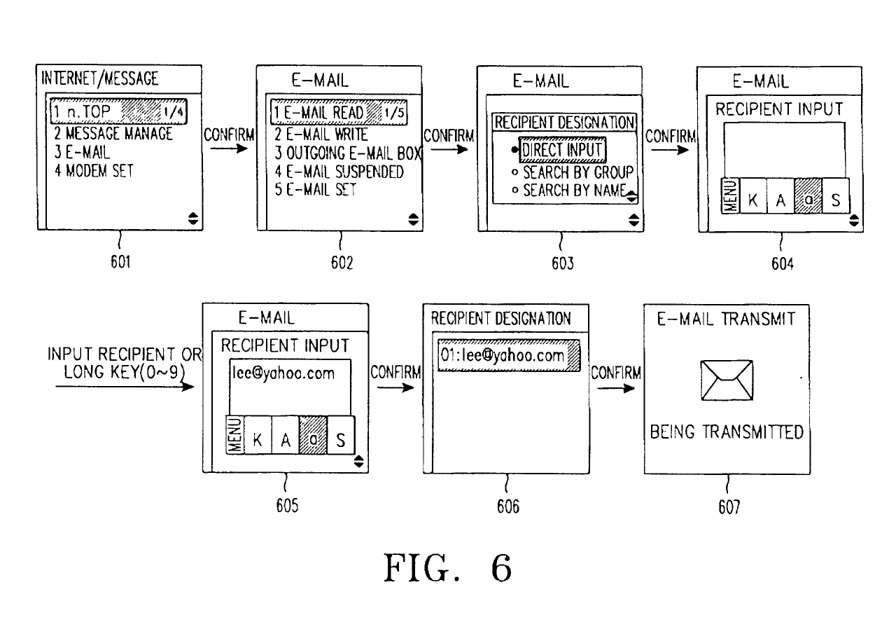

FIG. 6 illustrates an example of displays involved with transmitting an E-mail in the mobile terminal according to the embodiment of the present invention. Referring to FIG. 6, if the user selects a menu item “E-mail” from an Internet/message menu and presses the key Confirm, an E-mail menu is displayed. Upon selection of a menu item “E-mail write” and pressing of the key Confirm, a window to write a recipient's E-mail address on is invoked. After the user inputs the recipient's E-mail address (e.g., lee@yahoo.com) or a hot key corresponding to the recipient's E-mail address, the recipient's E-mail address is displayed. Then, when the user presses the key Confirm, a message “being transmitted” is displayed.

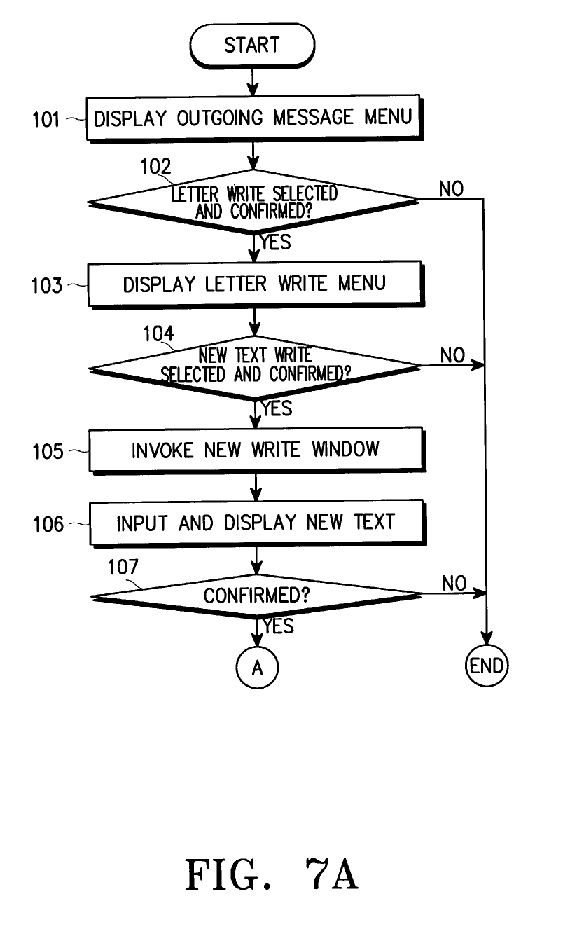

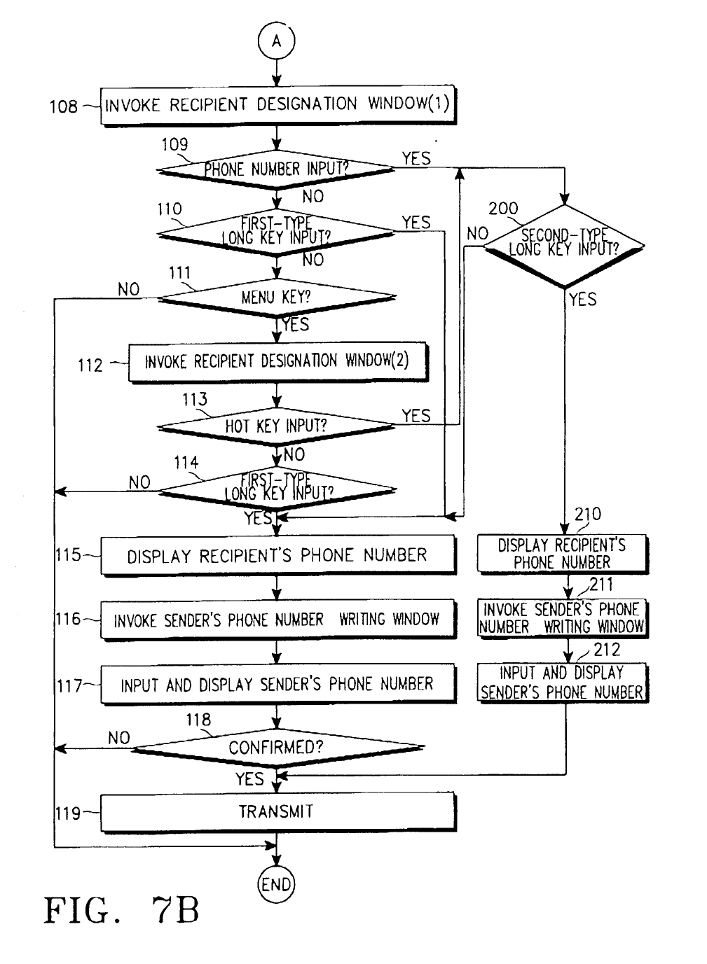

FIGS. 7A and 7B are flowcharts illustrating an SMS message transmitting method in the mobile terminal according to the embodiment of the present invention. Referring to FIG. 7A, if an outgoing message menu is displayed as illustrated in FIG. 4 in step 101, it is determined whether the user has selected a menu item “letter write” and pressed the Confirm key in step 102. Upon selection of the menu item “letter write” and pressing of the Confirm key, a letter write menu is displayed in step 103. If the user selects a menu item “new text write” and presses the Confirm key in step 104, a window to write a new text on is invoked on the display 10 in step 105. In step 106, a new sentence input by the user is displayed (e.g., Hello). If the user presses the Confirm key in step 107, it is determined that text editing has been completed and then a window to designate a recipient on is invoked in step 108. The user enters a recipient's phone number (e.g., 011300300) by hand in step 109, or presses a first-type long key corresponding to the phone number of the recipient in step 110. Then, the recipient's phone number is displayed in step 115 and a window to write a user's phone number on is invoked in step 116. In step 117, a phone number manually entered by the user or a pre-registered phone number is automatically displayed (e.g., 0119769410). It is determined whether the user has pressed the Confirm key in step 118. Upon sensing the Confirm key input, a message “being transmitted” is displayed and message transmission is carried out contemporaneously in step 119.

Meanwhile, if no first-type long key is input in step 110, it is determined whether the Menu key has been pressed in step 111. Upon pressing the Menu key, a window to designate a recipient on is invoked as illustrated in FIG. 5, that is, a window allowing the user to enter a hot key is invoked in step 112. In step 113, it is determined whether a hot key has been received. Upon input of the hot key, a phone number corresponding to the hot key is searched for in a phone book and the phone number is displayed in step 115. Otherwise, it is determined whether a first-type long key has been received in step 114. Upon input of the first-type long key, a phone number corresponding to the first-type long key is searched for in the phone book and the procedure goes to step 115.

Upon manual input of the recipient's number (e.g., 011300300) in step 109, or upon input of a hot key (at least two digits) in step 113, it is determines whether a second-type long key (prolonged pressing of the last digit) has been pressed in step 200. Upon input of the second-type long key, the recipient's number is displayed in step 210 and a window to write the user's number on is invoked in step 211. In step 212, the user's phone number is manually input or automatically displayed. Then, a message “being transmitted” is displayed and message transmission is carried out contemporaneously in step 119.

If no second-type long key is input in step 200, the procedure goes to step 115.

In step 110, 114, or 200, a specific key is pressed long. The first-type long key pressed in steps 110 and 114 is a one-digit number. Use of the first-long key facilitates search and display of a corresponding number irrespective of an input mode (digit input mode and hot key input mode). The second long key pressed in step 200 is a general long key for automatic dialing. When the user presses the last digit of a phone number or a hot key having at least two digits long, the phone number is searched for and dialing at the phone number is automatically carried out. Needless to say, an E-mail can be transmitted in the same manner and recipient designation can be done in English as illustrated in FIGS. 7A and 7B.

As described above, the present invention advantageously facilitates transmission of an SMS message and an E-mail by reducing the time required to designate a recipient. Further, the user only has to memorize a hot key or a long key instead of a long phone number in the case of an SMS message and instead of a long Email address when sending an E-mail.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. An apparatus for designating a recipient when transmitting a message in a mobile terminal, comprising:
a memory for assigning hot keys to message recipients for short dialing;
a searcher for searching for a recipient corresponding to a hot key upon input of the hot key from a user; and
a display for displaying the searched recipient.

2. The apparatus of claim 1, wherein the message is an SMS (Short Message Service) message and the searched recipient is registered by a phone number.

3. The apparatus of claim 1, wherein the message is an E-mail and the searched recipient is registered by an E-mail address.

4. The apparatus of claim 1, wherein the message is an MSMS (Multimedia SMS) and the searched recipient is registered by a phone number.

5. The apparatus of claim 1, wherein the message is a note and the searched recipient is registered by a phone number.

6. The apparatus of claim 1, wherein the hot key has at least two digits and when a user presses the last digit of the hot key and holds it down for a predetermined period of time, the searcher searches for the recipient corresponding to the hot key in the memory and displays the recipient on the display, transmitting a message contemporaneously.

7. The apparatus of claim 1, wherein first-type long keys each having one digit are assigned to message recipients on a one-to-one basis and when a digit is pressed and held down for a predetermined period of time, the searcher searches for a first-type long key is set and a recipient corresponding to the first-type long key in the memory.

8. The apparatus of claim 7, wherein the display displays a window prompting the user to select between a digit input mode and a hot key input mode, and the searcher searches for a recipient when the user presses a first-type long key in the digit input mode or the hot key input mode, or a hot key in the hot key input mode.

9. A method of designating a recipient when transmitting a message in a mobile terminal, comprising the steps of:
(1) providing a recipient designation display;
(2) displaying a recipient if a user inputs the recipient directly or a long key corresponding to the recipient; and
(3) transmitting a message to the recipient.

10. The method of claim 9, wherein the step (2) comprises the steps of:
(2-1) transitioning to a hot key input mode upon input of a Menu key, and displaying the recipient designation display;
(2-2) searching for the recipient corresponding to a hot key or a first-type long key if the hot key or the first-type long key is input in the hot key input mode while the recipient designation display is provided, and displaying the recipient; and
(2-3) performing the step (3) upon input of a Confirm key from the user with the searched recipient displayed.

11. The method of claim 10, further comprising the step of searching for the recipient to a second-type long key in a memory when the last digit of the hot key is pressed and held down for a predetermined period of time and thus the second-type long key is set with the recipient designation display provided in the hot key input mode, displaying the recipient, and then performing the step (3).

12. The method of claim 9, wherein the message is an SMS (Short Message Service) message and the searched recipient is registered by a phone number.

13. The method of claim 9, wherein the message is an E-mail and the searched recipient is registered by an E-mail address.

14. The method of claim 9, wherein the message is an MSMS (Multimedia SMS) and the searched recipient is registered by a phone number.

15. The method of claim 9, wherein the message is a note and the searched recipient is registered by a phone number.
